(19) United States
(12) Patent Application Publication
(10) Pub. No.: US 2026/0044026 A1
(43) Pub. Date: Feb. 12, 2026

(54) OPTICAL PHASE MODULATOR AND ASSOCIATED METHOD AND SYSTEMS

(71) Applicant: COMMISSARIAT À L'ÉNERGIE ATOMIQUE ET AUX ÉNERGIES ALTERNATIVES, PARIS (FR)

(72) Inventors: Sylvain GUERBER, GRENOBLE CEDEX 09 (FR); Jonathan FAUGIER-TOVAR, GRENOBLE CEDEX 09 (FR); Daivid FOWLER, GRENOBLE CEDEX 09 (FR); Leopold VIROT, GRENOBLE CEDEX 09 (FR)

(21) Appl. No.: 19/100,746

(22) PCT Filed: Aug. 3, 2023
(86) PCT No.: PCT/EP2023/071564

§ 371 Date: Feb. 3, 2025

(30) Foreign Application Priority Data
Aug. 4, 2022 (FR) FR2208100

(51) Int. Cl. G02F 1/01

(52) U.S. Cl. CPC G02F 1/011; G02F 2203/50

(57) ABSTRACT

An optical phase modulator includes a first layer made of dielectric material with a waveguide and a heater extending therein; at least one upper trench arranged above the heater and side trenches arranged on either side of the waveguide and the heater, and a second layer made of dielectric material extending over the first layer made of dielectric material and covering each first, second and third trench.

### TECHNICAL FIELD OF THE INVENTION

The technical field of the invention is that of optical phase modulators that are usable in an optical phased array and/or in a laser remote sensing system, called light detection and ranging (LIDAR) system.

### TECHNOLOGICAL BACKGROUND OF THE INVENTION

A phase modulator is to be used in optical phased array (OPA) circuits. It is provided in the context of Light Detection and Ranging (LiDAR) systems.

There are many types of phase modulator utilising different physical effects (Pockels, Kerr, plasma dispersion, etc.) having in common that they modify refractive index of the material in which they are present if an electric field is applied thereto (electro-optical modulation). If an optical signal is passed through a material whose refractive index is modified, light will travel faster (or slower, depending on the direction of variation of the refractive index), resulting in a change in the phase of the signal. Modulators that utilise these effects provide very good performance in terms of power consumption and bandwidth, however their integration is complex (specific materials, doping, etc.). In addition, phase modulation is intrinsically accompanied with an amplitude modulation of the optical signal (absorption of part of the optical power) which, within the scope of an OPA, is not desirable. This is why the majority of OPAs made in silicon photonics are generally based on thermo-optic modulators that utilise the temperature dependence of the refractive index of a material (thermo-optic coefficient).

Thus, by heating (or cooling) this material, its refractive index will be modified which, as with electro-optical modulators, results in a change of phase for a signal propagating in this material.

Thermo-optical modulators are generally made by placing a Ti/TiN heater (above the waveguide) in which an electric current is circulated to heat the heater (and therefore the waveguide) by the Joule effect. This type of modulator has the advantage of being relatively simple to implement, and especially of providing “pure” phase modulation (no amplitude modulation), which is of particular interest within the scope of an OPA. Moreover, they are also relatively compact in both width and length, by virtue of the high thermo-optic coefficient of the materials used in photonics (Si, SiN, etc.).

These modulators are generally coated with a dielectric material and can therefore be integrated. Additional manufacturing steps can be performed without degrading performance of the modulator.

However, these modulators have a few drawbacks all the same. Apart from a bandwidth limited to a few tens of kHz, the main drawback of thermo-optical modulators is their efficiency. Indeed, heat generated will spread in all directions, which will severely limit efficiency of the modulator. This is generally measured in mW/TT, which corresponds to the electrical power injected into the TiN heater to obtain a IT phase shift in the optical signal.

To remedy this problem, insulation trenches are generally added on either side of the modulator. This will confine heat produced by the heater and thus maximise the temperature variation in the guide (and therefore the phase variation) for a given electric power. To further improve heat confinement, it is possible to suspend the thermo-optical modulator by performing etching of the substrate under the waveguides.

However, the insulation trenches remain open and do not allow the modulator to be integrated. Additional manufacturing steps could plug the trenches and cancel out their effect.

There is a need to provide a high-performance optical phase modulator that can be integrated.

### SUMMARY OF THE INVENTION

The invention addresses the above problem by providing an optical phase modulator comprising:
a first layer of dielectric material extending in a plane in which at least one waveguide and at least one heater extend along a first direction parallel to the plane, said at least one heater being disposed above said at least one waveguide and thermally coupled to a portion of said at least one waveguide, the first layer of dielectric material comprising, for each waveguide:
   at least one first trench, extending along a second direction, parallel to the plane and perpendicular to the first direction, disposed above the heater thermally coupled to the waveguide;
   a second trench and a third trench each extending along the first direction, on either side of the waveguide and of the heater thermally coupled to the waveguide, said at least one first trench disposed above the heater thermally coupled to the waveguide opening into the second trench and into the third trench;
a second layer of dielectric material extending in parallel to the plane and on the first layer of dielectric material and covering each first, second and third trench.

By the term “a layer in which an element extends”, it is meant that said element is comprised in the layer and is at least partially coated with it.

By “heater”, it is meant a conductive track for generating a heat quantity when an electric current passes therethrough.

The terms “above” and “below” refer to a direction perpendicular to the plane.

By “trench in a layer”, it is meant a cavity dug from the surface of said layer and at some depth. By “trench extends along one direction parallel to the plane”, it is meant that the dug cavity has a constant depth along said direction. By “cavity”, it is meant that it is free of any solid body. It is empty or comprises a gas or air.

By “trenches extending on either side of the waveguide”, it is meant that the trenches extend on either side of the waveguide and at least over the entire height of the waveguide (measured perpendicularly to the plane).

The heater, thermally coupled to the waveguide, makes it possible to modulate its optical index. The phase of an optical beam passing through the waveguide can therefore be modulated. Each of the first, second and third trenches thermally insulates each heater and each waveguide from the external environment. In this way, the heat generated by the heater that is not transferred to the waveguide is reduced. A substantial proportion of heat generated by each heater is therefore transferred to a waveguide, thereby improving modulation efficiency of the waveguide index, making it a high-performance modulator.

The second layer of dielectric material closes the trenches and thus prevents them from being filled with a material (e.g. liquid, oxide or metal) during integration steps. Each heater and each waveguide therefore remain thermally insulated and therefore operational after integration steps. The modulator can therefore also be integrated.

Advantageously, for each waveguide, the second trench and the third trench are discontinuous and each comprise segments separated from each other by the dielectric material of the first layer, aligned along the first direction. A distance separating two consecutive segments is preferably less than 100 μm, or even less than or equal to 5 μm. Preferably, each first trench disposed above the heater thermally coupled to the waveguide opens into a segment of the second trench and into a segment of the third trench.

Advantageously, the modulator comprises a semiconductor substrate on which the first layer of dielectric material extends, the semiconductor substrate comprising, for each waveguide, a fourth trench extending along the first direction and disposed under said waveguide, each second trench and each third trench on either side of the waveguide opening into the fourth trench.

Advantageously, for each waveguide, a distance separating two first consecutive trenches along the first direction is less than 5 μm.

Alternatively, for each waveguide, the first layer of dielectric material comprises a single first trench whose width, measured along the first direction, is greater than 50% of the length of the heater thermally coupled to the waveguide.

Advantageously, the modulator comprises at least ten waveguides and preferably at least one hundred waveguides.

The invention also relates to a method for manufacturing an optical phase modulator, comprising the following steps of:
forming a first layer of dielectric material extending in a plane, in which at least one waveguide and at least one heater extend along a first direction parallel to the plane, said at least one heater being disposed above said at least one waveguide and thermally coupled to a portion of said at least one waveguide;
etching the first layer of dielectric material so as to form, for each waveguide, at least one first trench, extending along a second direction, parallel to the plane and perpendicular to the first direction, disposed above the heater thermally coupled to the waveguide;
etching the first layer of dielectric material so as to form, for each waveguide, second and third trenches each extending in the first direction, on either side of the waveguide and of the heater thermally coupled to the waveguide, each first trench disposed above the heater thermally coupled to the waveguide opening into the second trench and into the third trench;
forming a second layer of dielectric material extending in parallel to the plane and on the first layer of dielectric material and covering each trench.

Advantageously, the step of forming the second layer of dielectric material comprises, before the step of etching the second and third trenches, the following sub-steps of:
filling each first trench with a sacrificial material;
depositing the second layer of dielectric material onto the first layer of dielectric material and covering the sacrificial material in each first trench;
   the step of etching the second and third trenches being performed through the second layer of dielectric material, the step of forming the second layer of dielectric material also comprising, after the step of etching the second and third trenches, the following sub-steps of:
removing the sacrificial material from each first trench disposed above each heater; and
thickening the second layer of dielectric material so that it covers each second and third trench.

Preferably, the step of thickening the second layer of dielectric material is performed by depositing a low-density oxide.

The invention also relates to an optical phased array comprising:
a plurality of antennae, aligned along one direction and distributed along this direction at a constant pitch;
a power divider configured to divide optical power of an incident coherent optical beam, the incident optical beam having a wavelength greater than or equal to the constant pitch;
   the optical phased array being remarkable in that it comprises:
an optical phase modulator according to the invention, said modulator comprising a plurality of waveguides, each waveguide of the modulator forming part of the optical path between the power divider and one of the plurality of antennae; or
a plurality of optical phase modulators according to the invention, each modulator comprising a single waveguide, the waveguide of each modulator forming part of the optical path between the power divider and one of the plurality of antennae.

The invention also relates to a laser remote sensing system comprising a phased array antenna according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention. Unless otherwise specified, a same element appearing in different figures has a single reference.

FIG. 1a, FIG. 1b and FIG. 1c schematically represent, in three cross-section views, a first embodiment of an optical phase modulator according to the invention.

FIG. 2a and FIG. 2b schematically represent, in two cross-section views, a second embodiment of the optical phase modulator according to the invention.

FIG. 3a and FIG. 3b schematically represent, in two cross-section views, a third embodiment of the optical phase modulator according to the invention.

FIG. 4a and FIG. 4b schematically represent, in two cross-section views, a fourth embodiment of the optical phase modulator according to the invention.

FIG. 5a, FIG. 5b, FIG. 5c and FIG. 5d schematically represent, in four cross-section views, a fifth embodiment of the optical phase modulator according to the invention.

FIG. 6 schematically represents an embodiment of a manufacturing method according to the invention.

FIG. 7 schematically represents an alternative embodiment of the manufacturing method of FIG. 6.

FIG. 8a, FIG. 8b, FIG. 8c, FIG. 8d, FIG. 8e and FIG. 8f schematically represent, in two cross-section views, steps of the manufacturing method of FIG. 7.

FIG. 9 schematically represents an example of an optical phase modulator likely to be obtained by implementing the manufacturing method of FIG. 7.

FIG. 10 schematically represents a first embodiment of an optical phased array according to the invention.

FIG. 11 schematically represents a second embodiment of the optical phased array according to the invention.

### DESCRIPTION

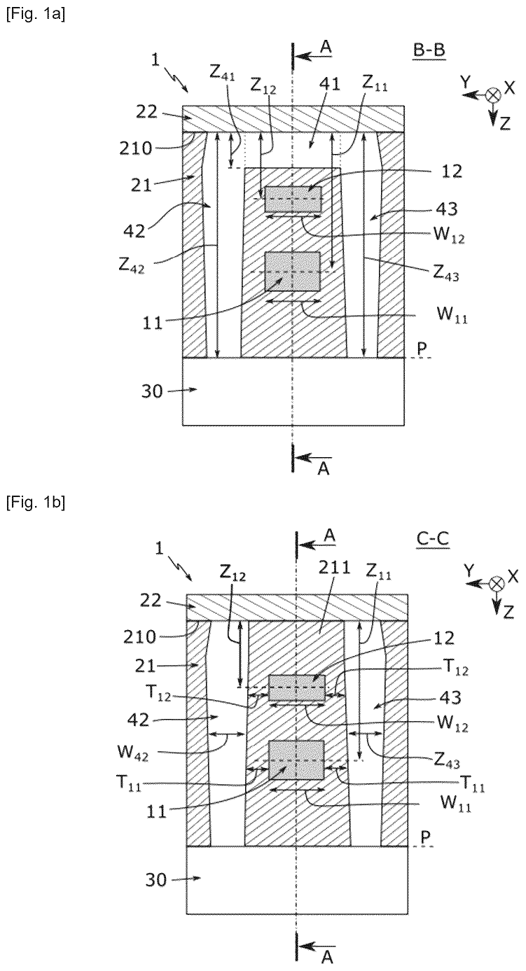

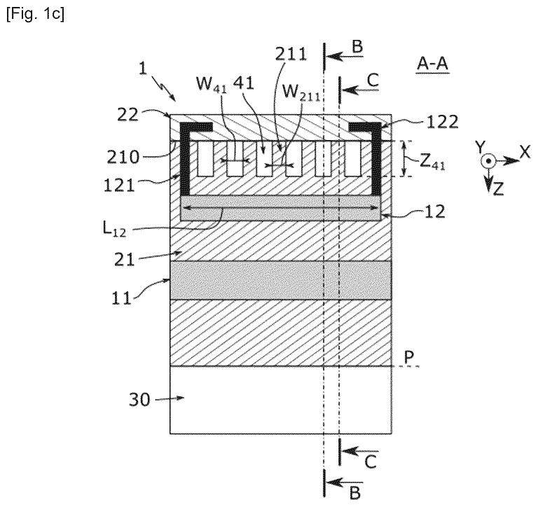

FIG. 1a, FIG. 1b and FIG. 1c schematically represent, in three cross-section views A-A, B-B, C-C, an optical phase modulator 1 according to a first embodiment according to the invention.

The modulator 1 comprises two layers 21, 22 of dielectric material. The first layer 21 extends in a plane P. The plane P corresponds, for example, to the surface of a semiconductor substrate 30 on which the first layer 21 extends. The second layer 22 also extends in the plane P (i.e. in parallel to this plane P). It extends on the first layer 21. The two layers 21, 22 are for example of SiO₂. The substrate 30 is for example of Si.

The modulator 1 comprises a waveguide 11 and a heater 12, each extending in parallel to the plane P and more particularly along a same first direction X. In this example, waveguide 11 has a sufficiently long length, greater than 1000 μm, for it to be considered infinite. The heater 12 in turn has a length L₁₂, measured along the first direction, of between 100 μm and 500 μm. The heater 12 is disposed above the waveguide 11, i.e. vertically (along direction Z) to the waveguide 11. In particular, the heater 12 is disposed between the waveguide 11 and the second layer 22 of dielectric material (in other words, in vertical alignment with the waveguide 11, between the waveguide and the upper surface of the first layer 21). For example, considering the upper surface 210 of the first layer as a reference height, measured perpendicularly to the plane P, then the heater 12 is located, for example, at a height Z₁₂ (or depth) of between 1 μm and 9 μm below the upper surface 210. The waveguide may be at a depth Z₁₁ of between 4 μm and 10 μm.

The heater 12 may have a thickness, measured along direction Z, of between 50 nm and 200 nm. It may have a width W₁₂, measured along direction Y, of between 300 nm and 1000 nm.

The waveguide 11 can have a thickness of between 100 nm and 1000 nm and a width of between 100 nm and 1000 nm.

The heater 12 is configured to heat a portion of the waveguide 11 so as to raise its temperature and modify its optical index. Advantageously, the waveguide 11 then has a temperature-dependent optical index. The waveguide 11 is for example a semiconductor material such as Si or a nitride such as SiN. The heater 12 is preferably an electrical conductor, for example made of Ti or TiN. The heater 12 is thermally coupled to a portion of the waveguide 11. It is for example a portion along the waveguide located under the heater 12, thus having a length equal to the length L₁₂ of the heater 12. Thermal coupling between the heater 12 and the waveguide 11 is achieved by means of the dielectric material forming the first layer 21. A different dielectric material with better thermal properties could also be used.

Preferably, the heater 12 is electrically connected to vias 121, 122 for circulating an electric current through the heater 12.

In this embodiment, the waveguide 11 and the heater 12 extend into the first layer 21. In other words, they are coated with the dielectric material forming the first layer 21. The first layer 21 is particular in that it comprises a plurality of trenches for insulating the waveguide 11 and the heater 12 from the external environment, and in particular from the external thermal bath.

In the embodiment of FIG. 1a, FIG. 1b and FIG. 1c, the first layer 21 comprises a plurality of first trenches 41, also designated “upper trenches”, extending along a second direction Y, parallel to the plane P and perpendicular to the first direction X. The upper trenches are disposed vertically above the heater 12 and are distributed along the first direction X. The upper trenches 41 are, for example, the result of an anisotropic etching step in the first layer 21. They have, for example, a depth Z₄₁ constant to within +/−20% and flanks perpendicular to the plane P to within +/−20°. The upper trenches 41 are disposed between the heater 12 and the second layer 22. They therefore serve to insulate the heater 12 from the second layer 22.

Each trench 41 may have a depth Z₄₁, measured from the upper surface 210 of the first layer 21, of between 100 nm and 1000 nm. Each trench 41 may additionally have a depth Z₄₁ enabling it to reach the heater 12 and partially expose it.

The upper trenches 41 are preferably distributed along the first direction X and spaced from each other. They are therefore separated by portions 211 of the first layer 21. These portions 211 extend vertically between each upper trench 41 and are oriented along the second direction Y. They thus form walls, also known as “low walls”, separating the upper trenches 41 from each other. The low walls 211 are also distributed along direction X.

Thermal leakage between the heater 12 and the second layer 22 partly depends on the width W₂₁₁ of the low walls separating two consecutive upper trenches 41. In order to ensure reduced thermal leakage, the walls preferably have widths W₂₁₁ of less than 5 μm and preferably greater than 100 nm, since they define one of the dimensions of thermal contact between the heater 12 and the second layer 22. The number of upper trenches 41 and the width W₄₁ (measured along the first direction X) of these trenches 41 are then advantageously dimensioned to minimise the width W₂₁₁ of the low walls 211 and therefore minimise the thermal leakage between the heater 12 and the second layer 22. For example, a large number of upper trenches 41 (which may have a small width W₄₁) or a small number of upper trenches 41 but with a large width W₄₁ will be selected.

In the case where the first layer 21 comprises several upper trenches 41, for example around ten, then the width W₄₁, measured along the first direction X, may be between 10 μm and 200 μm. In this embodiment, the number of upper trenches 41 is limited by the vias 121, 122. A different arrangement of the vias could be contemplated to increase the number of upper trenches so that they are distributed over the entire length of the heater 12.

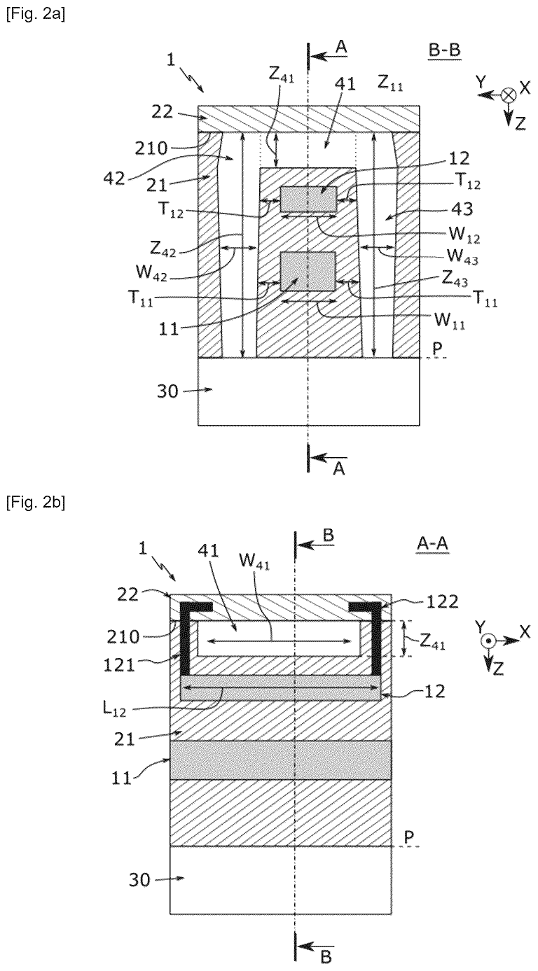

FIG. 2a and FIG. 2b schematically represent, in two cross-section views, a second embodiment of the modulator 1. Unlike FIG. 1a, FIG. 1b, FIG. 1c, the first layer 21 comprises only a single upper trench 41 but sufficiently wide to effectively insulate the heater 12 from the second layer 22. There is therefore no low wall 211 providing thermal contact between the heater 12 and the second layer 22. The upper trench 41 has for example a width W₄₁ equal to 85% of the length L₁₂ (measured along X) of the heater 12. The upper trench 41 has, for example, a width W₄₁ of between 100 μm and 500 μm. In this embodiment, the width W₄₁ of the upper trench 41 is limited by the vias 121, 122. A different arrangement of the vias could allow the width of the upper trench 41 to be further extended until the upper trench 41 extends along the entire length of the heater 12.

The low walls 211 can be of interest because they can support the second layer 22, transferring, for example, mechanical stresses applied to the second layer 22 to the underlying structure (comprising, among other things, the heater 12 and the waveguide 11). They therefore prevent the second layer 22 from collapsing and filling the trenches 41, 42, 43.

In common with FIG. 1a, FIG. 1b, FIG. 1c and FIG. 2a, FIG. 2b, the first layer 21 also comprises second and third trenches 42, 43, which will also be designated “side trenches”, extending on either side of the waveguide 11 and the heater 12. The side trenches 42, 43 extend along the first direction X. These trenches 42, 43 insulate the waveguide 11 and heater 12 from the rest of the first layer 21. In order to provide adequate thermal insulation, the side trenches 42, 43 have depths Z₄₂, Z₄₃, measured from the second layer 22, greater than or equal to the depth Z₁₁ of the waveguide 11. Thus, these trenches form an insulating channel between the heater 12 and the waveguide 11 enabling a substantial portion of the heat generated by the heater 12 to be transferred. In order to reduce heat leakage from the waveguide 11, it is advantageous for the side trenches to have depths Z₄₂, Z₄₃ greater than or equal to 150% of the depth Z₁₁ of the waveguide 11. They are, for example, between 6000 nm and 15000 nm.

The side trenches 42, 43 are for example the result of an anisotropic etching step in the first layer 21. They have for example depths Z₄₂, Z₄₃ constant to within +/−20% and flanks perpendicular to the plane P to within +/−20°.

The side trenches 42, 43 advantageously extend at least along the entire length L₁₂ of the heater 12 so as to minimise thermal leakage along the first direction X. They may also have widths W₄₂, W₄₃, measured along the second direction Y, of between 100 nm and 1000 nm respectively. The wider the side trenches 42, 43, the better the thermal decoupling of the heater 12 and the waveguide 11 from the external thermal bath.

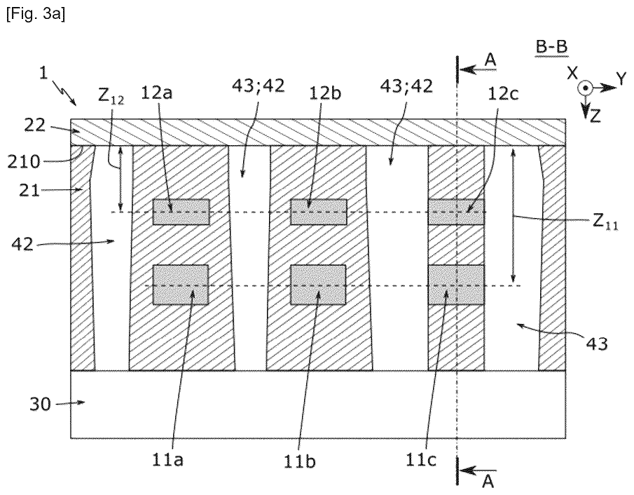

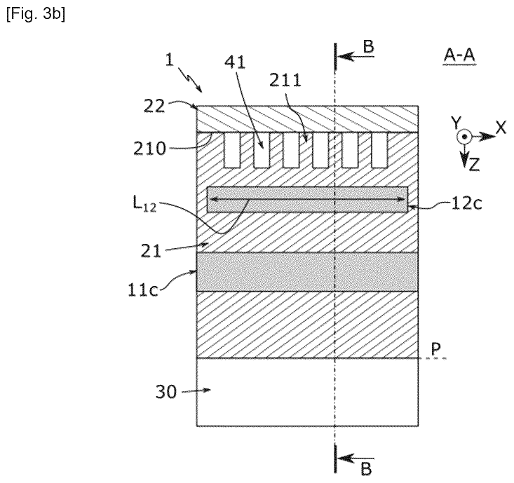

Each side trench 42, 43 may be made such that it exposes one side of the heater 12 and/or one side of the waveguide 11 (illustrated for example for the heater 12c and the waveguide 11c in FIG. 3a). According to one alternative, each side trench 42, 43 is spaced from the heater 12 by a distance T₁₂, measured along the second direction Y, of between 100 nm and 1000 nm and/or from the waveguide 11 by a distance T₁₁, also measured along the second direction Y, of between 100 nm and 1000 nm.

In order to better insulate the heater 12 from the first and second layers 21, 22, each upper trench 41 extends along the second direction Y so as to open into each side trench 42, 43. There is therefore no thermal bridge between the different trenches 41, 42 and 43, providing better insulation for the heater 12 and the waveguide 11.

The second layer 22 extends in the plane P and on the upper surface 210 of the first layer 21. It thus seals the trenches 41, 42, 43 and the insulating volume of the heater 12 and the waveguide 11. The second layer 22 thus delimits an internal volume, that of the trenches 41, 42, 43, from an external volume, above the second layer 22, in which the steps of integrating the modulator 1 can take place. The second layer 22 extends in parallel to the plane P and rests on the upper surface 210 of the first layer 21. Thus, the second layer 22 does not fill the trenches 41, 42, 43.

The modulator 1 according to the invention therefore makes it possible to reduce the power P_{π} required to modulate the phase of an optical beam from π. In a modulator according to prior art comprising no trenches, the power required is estimated to P_{π}^{AA}=20 mW. The modulator 1 according to the invention makes it possible to obtain a power P_{π}=5 mW, i.e. reduced by a factor of 4.

FIG. 3a and FIG. 3b schematically represent a third embodiment of the modulator 1. It differs from the embodiment of FIG. 1a, FIG. 1b, FIG. 1c in that the modulator 1 comprises a plurality of waveguides 11. In this example, the modulator comprises three waveguides 11a, 11b, 11c and three heaters 12a, 12b, 12c. It is quite contemplatable that the modulator 1 comprises a greater number of waveguides 11, such as about ten waveguides 11, or even a greater number, for example between one hundred and one thousand waveguides 11.

Each waveguide 11a-c extends in parallel to the plane P. The three waveguides 11a-c extend in a same plane, for example, at a constant depth Z₁₁ relative to the upper surface of the first layer. The three heaters 12a-c also extend in a same plane, at a depth Z₁₂. Each heater 12a-c is disposed vertically (along direction Z) above one of the waveguides 11a-c. Each waveguide 11a-c is therefore disposed under a single heater 12a-c.

Each waveguide 11a-c has corresponding second and third trenches 42, 43, extending along the first direction X and on either side of a waveguide 11a-c. The first layer 21 therefore comprises three second trenches 42 and three third trenches 43. In this embodiment in particular, a second trench 42 may be one and the same as a third trench 43. For example, the third trench 43 of a first waveguide 11a is one and the same as the second trench 42 of a second waveguide 11b.

In this embodiment, all the waveguides 11 and all the heaters 12 are in a same chamber formed by all the trenches. In this embodiment, the first layer 21 advantageously comprises, for each waveguide 11, a plurality of upper trenches 41. In other words, the first layer 21 comprises, for each waveguide 11, at least one portion 211, known as “low walls”, providing mechanical support for the second layer 22. Thus, even when the modulator 1 comprises a large number of waveguides 11 (a thousand, for example), the second layer 22 does not present any risk of collapse.

According to one development of this embodiment, the second trench 42 of the second waveguide 11b can be separated from the third trench 43 of the first waveguide 11a, for example by means of an unetched part of the first layer 21, forming a wall between the two trenches 42, 43. This wall can also provide mechanical support for the second layer 22. However, this development has an increased lateral bulk, due to the additional walls.

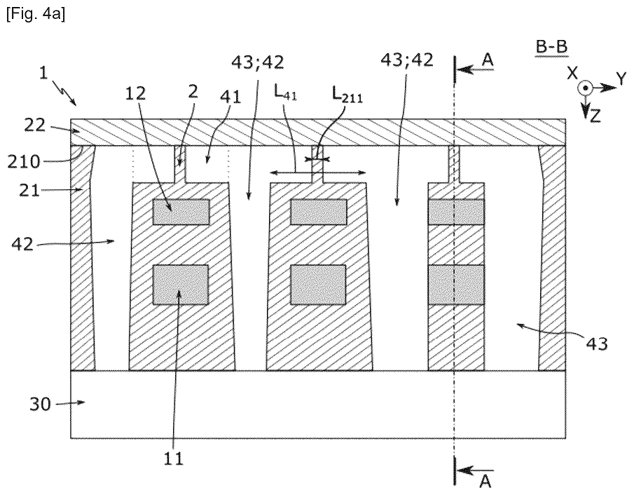

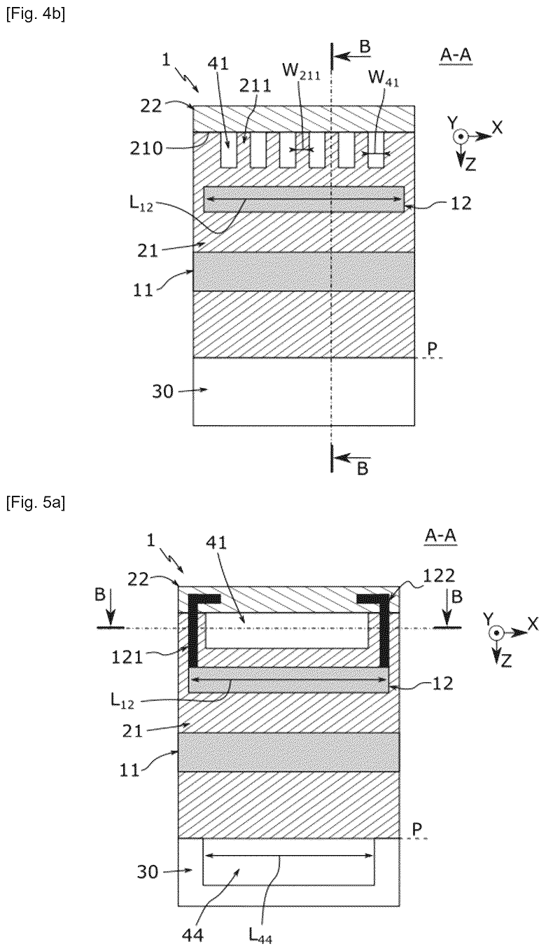

FIG. 4a and FIG. 4b schematically represent a fourth embodiment of the modulator 1. This embodiment differs from the embodiment of FIG. 3a and FIG. 3b in that the portions 211 of the first layer 21, known as “low walls”, only partially separate the upper trenches 41. Each low wall 211, for example, has a length L₂₁₁ less than the length L₄₁ of the upper trenches 41 that it separates. In this way, heat leakage between the heater 12 and the second layer 22 is further reduced while providing mechanical support for the second layer 22.

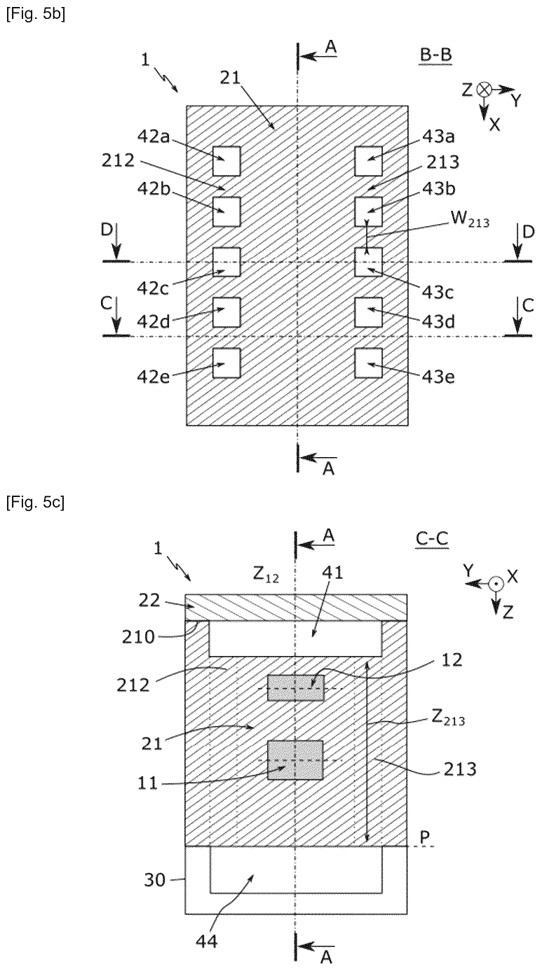

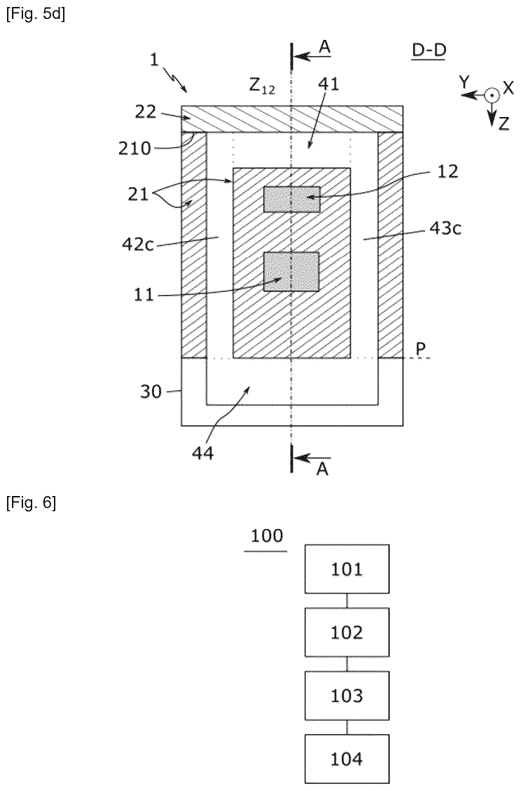

FIG. 5a, FIG. 5b, FIG. 5c and FIG. 5d schematically represent a fifth embodiment of the modulator 1. This embodiment differs from the embodiment of FIG. 2a and FIG. 2b in that the semiconductor substrate 30 on which the first layer 21 rests comprises a fourth trench 44, also designated “lower trench”. The lower trench 44 extends under at least one portion of the waveguide 11. It is disposed in vertical alignment with the portion of the waveguide 11 thermally coupled with the heater 12. It is therefore advantageously disposed in vertical alignment with the heater 12. The lower trench 44 further decouples the waveguide 11 and the heater 12 from the external environment. The lower trench 44 preferably extends along the first direction X. For example, it has a length L₄₄, measured along the first direction X, greater than 50% of the length L₁₂ of the heater 12, or even strictly greater than this length L₁₂. Preferably, the lower trench 44 extends over the same length as the side trenches 42, 43. In this way, it forms, with the side trenches 42, 43, an insulating channel between the heater 12 and the waveguide 11, making it possible to transfer substantial part of the heat generated by the heater 12 to the waveguide 11.

In the embodiment illustrated, each side trench 42, 43 opens into the fourth trench 44, making it possible to form an empty volume (or one comprising air or another gas) completely surrounding the assembly comprising the heater 12 and the waveguide 11.

In the absence of sufficient mechanical support (for example provided by the low walls 221), the part of the first layer 21 comprising the waveguide 11 and the heater 12 may sag into the lower trench 44. Indeed, in the embodiments of FIGS. 1a to 4b, the waveguide or waveguides 11 and the heater or heaters 12 are carried by the first layer 21, which is itself supported on the substrate 30. In the absence of support on the substrate 30, the waveguide 11 and the heater 12, the risk of sagging increases with the length L₄₄ of the lower trench 44. To avoid this sagging, the lower trench 44 can be discontinuous (like a broken line). It then includes successive segments, spaced apart from each other, aligned along the first direction X. These segments are, for example, distributed at a constant pitch along the first direction X. Two consecutive segments are then separated by a portion of the first layer 21 (similar to low walls 211). Each portion of the first layer 21 separating the segments of the lower trench 44 then provides mechanical support for the part of the first layer 21 comprising the waveguide 11 and the heater 12.

According to one development, the side trenches 42, 43 may also be discontinuous. Each of the side trenches 42, 43 also includes successive segments 42a-e, 43a-e, in the manner of a discontinuous line. Two consecutive segments 42a-e, 43a-e are separated by portions 212, 213 of the dielectric material of the first layer 21, also designated “fins”. The fins 212, 213 extend in parallel to a plane {Y; Z} and are distributed along the first direction. The fins 212, 213 thus provide mechanical support for the waveguide 11 and the heater 12.

In order to limit heat leakage through the fins 212, 213, they preferably have a thickness, measured along the first direction X, of less than 5 μm, for example between 100 nm and 2 μm. They extend, along direction Z, over a height Z₂₁₃ greater than or equal to the height between the heater 12 and the waveguide 11. Preferably, they extend over the entire height of the dielectric material of the first layer 21 coating the heater 12 and the waveguide 11, so as to ensure reliable mechanical contact.

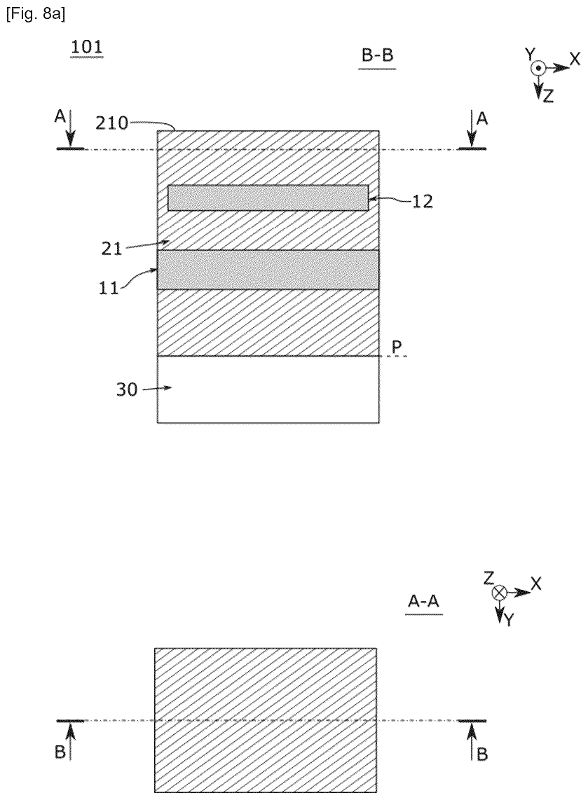

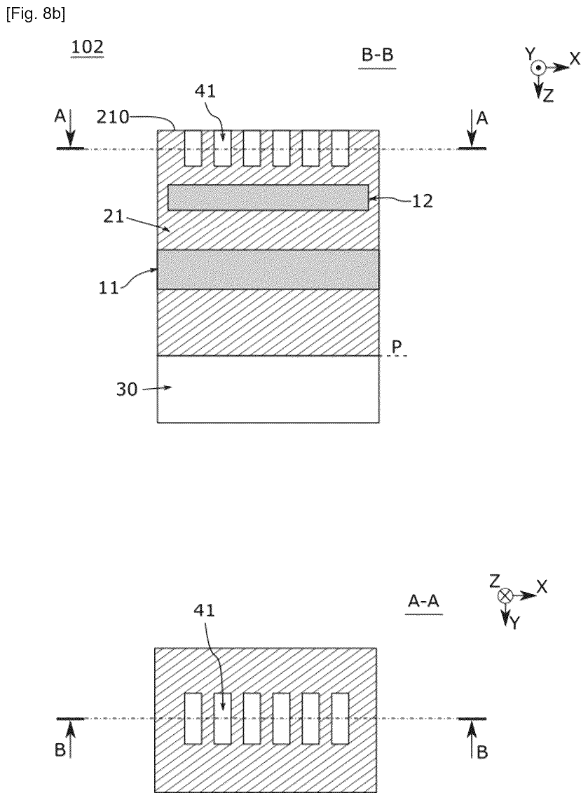

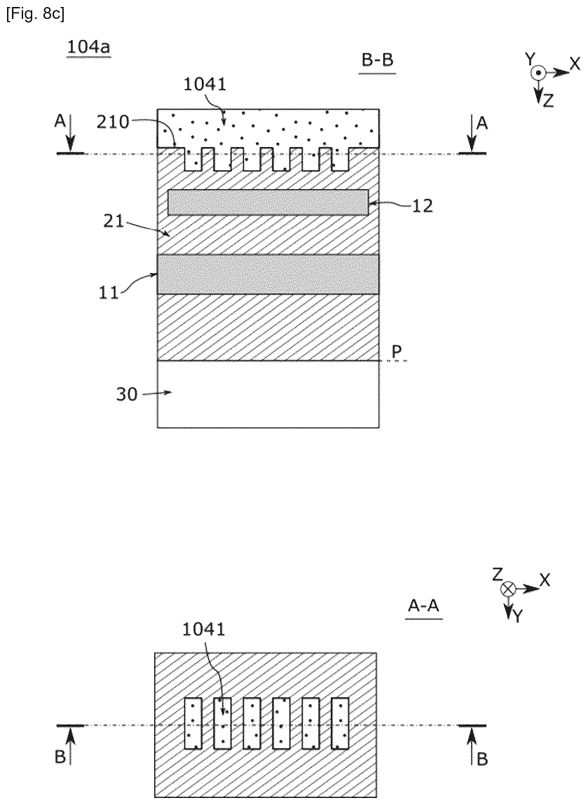

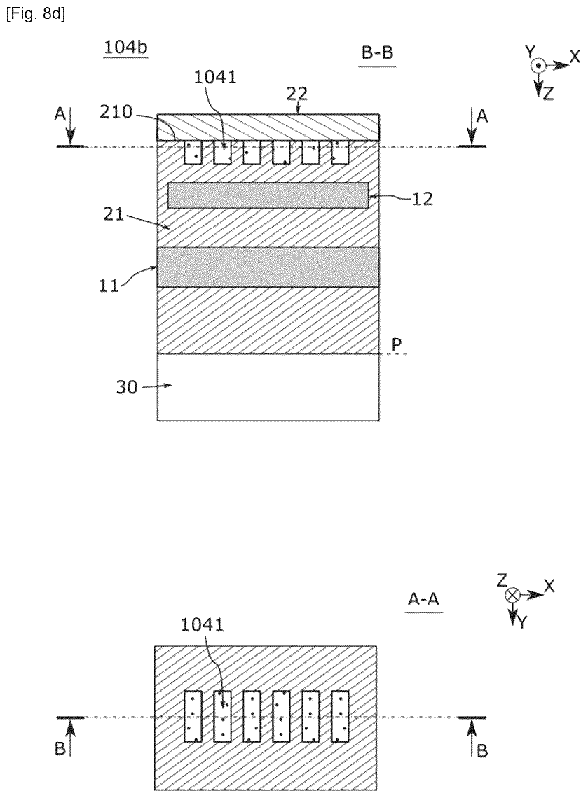

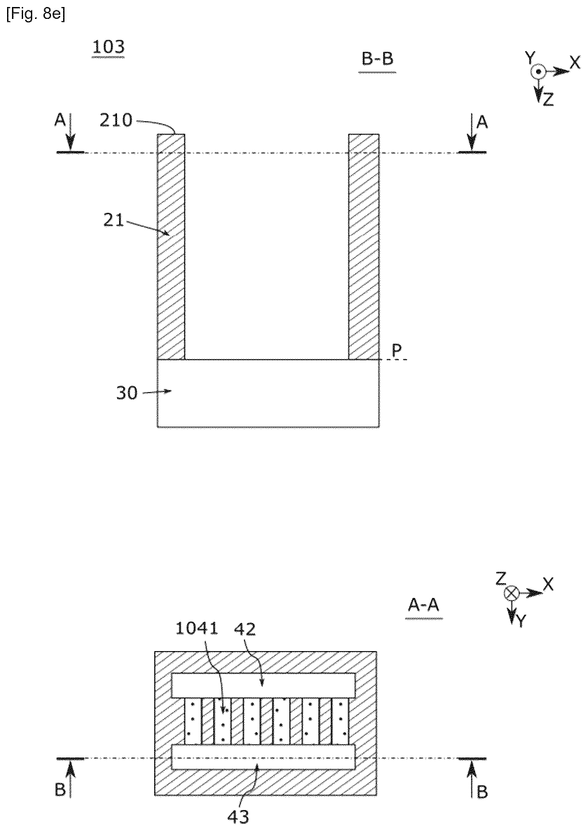

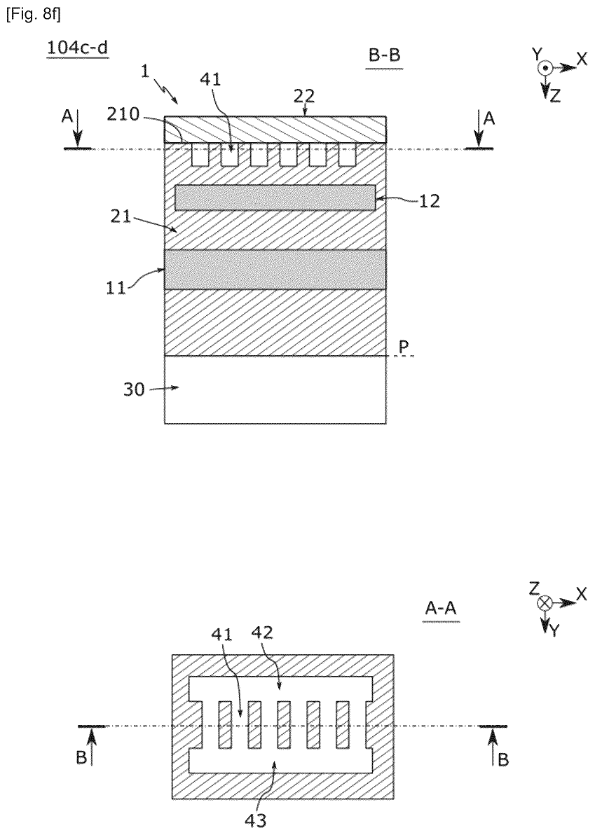

FIG. 6 schematically represents an embodiment of a method for manufacturing 100 for making the modulator 1 according to the invention. It is described with reference to FIG. 8a to FIG. 8f. The method 100 initially comprises a step 101 of forming a first layer 21 of dielectric material, as illustrated in FIG. 8a. In this step, the first layer 21 does not yet comprise the different trenches 41, 42, 43 as described above. The first layer 21 is deposited onto a semiconductor substrate 30 and comprises a waveguide 11 and a heater 12 thermally coupled to a portion of the waveguide 11. The dielectric material forming the first layer 21 may be an oxide semiconductor such as SiO₂. The waveguide 11 and the heater 12 are coated (or encapsulated) with the dielectric material.

The waveguide 11 can be made from a silicon-on-insulator (SOI) substrate. An SOI substrate thus comprises the semiconductor substrate 30 of the future device 1 as such, a silicon layer into which the waveguide 11 can be etched, and a layer of dielectric material 21 disposed between the silicon layer and the semiconductor substrate 30.

The method 100 also comprises a step of etching 102 the first layer 21, as illustrated in FIG. 8b, so as to form a plurality of first trenches 41 disposed above the heater 12. This is, for example, an anisotropic etching through a hard mask previously deposited.

The method 100 then comprises a further step of etching 103 the first layer 21, as illustrated in FIG. 8e, so as to form a second trench 42 and a third trench 43 on either side of the waveguide 11 and the heater 12. This may also be anisotropic etching made along direction Z, through a hard mask. Etching 103 is made in such a way as to intersect each first trench 41 so that they open into the second trench 42 and the third trench 43.

The method 100 finally comprises a step 104 of forming a second layer of dielectric material, as illustrated in FIG. 8f, extending in parallel to the upper surface of the first layer 21. The dielectric material forming the second layer 22 may also be a semiconducting oxide such as SiO₂. It is formed by depositing or bonding a layer of dielectric material onto the first layer 21 so as to cover each trench 41, 42, 43.

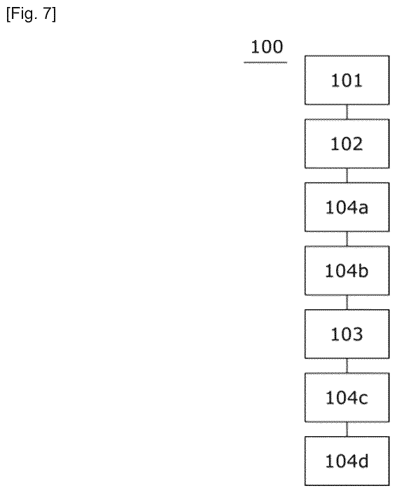

According to one alternative, illustrated by FIG. 7, the step of forming the second layer 104 may comprise four sub-steps 104a, 104b, 104c and 104d, illustrated by FIG. 8c, FIG. 8d and FIG. 8f. This alternative especially ensures that the second layer 22 does not collapse into the trenches 41, 42, 43 while being formed.

As such, the forming step 104 initially comprises, prior to the step 103 of etching the second and third trenches 42, 43, a sub-step of filling 104a each first trench 41 with a sacrificial material 1041, as illustrated in FIG. 8c. The sacrificial material 1041 is for example SiO₂, SiN, Ge or a polymer resin. The filling step 104a also comprises polishing an excess of sacrificial material 1041 down to the upper surface of the first layer 21.

The formation step 104 also comprises a sub-step 104b of depositing the second layer 22 onto the first layer 22 so as to completely cover the sacrificial material 1041 in the first trench 41. The sacrificial material 1041 thus provides support to prevent the second layer 22 from sagging.

In this alternative, the step 103 of etching the side trenches 42, 43 is performed through the second layer 22. The side trenches 42, 43 then open onto the upper surface of the second layer 22.

After etching 103 the side trenches, the formation step 104 also comprises the sub-step of removing 104c the sacrificial material 1041 from the first trenches 41, as illustrated in FIG. 8f. The openings left by the side trenches 42, 43 in the second layer 22 and the first trenches 41 opening into the side trenches 42, 43 make it possible to perform selective etching of the sacrificial material relative to the dielectric material of the first and second layers 21, 22. The first trenches 41 are thus released and the second layer 22 solely rests on the low walls 211 as described previously.

The second layer 22, which comprises an opening left by each side trench 42, 43, is closed during a sub-step 104d of thickening the second layer 22. A dielectric material is deposited onto the second layer 22 so as to thicken the second layer 22 along a direction perpendicular to the plane of the layers. This thickening 104d progressively closes the openings in the second layer 22. In order to limit the amount of material that falls into the side trenches 42, 43 during this thickening step, it advantageously implements the deposition of a low-density semiconductor oxide. The deposition of low density oxide is described by document [“Reducing BEOL Parasitic Capacitance Using Air Gaps”, Michael Hargrove, October 2017, Semiconductor Engineering, https://semiengineering.com/reducing-beol-parasitic-capacitance-using-air-gaps].

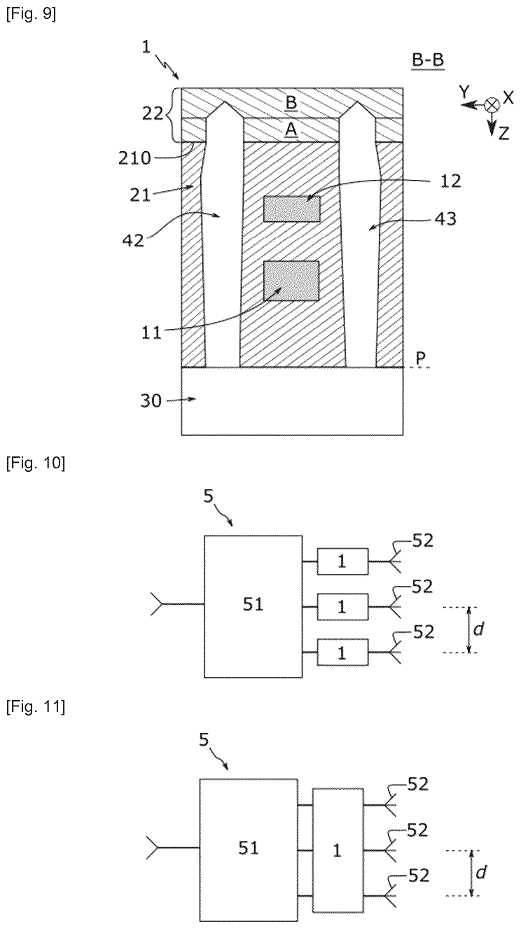

FIG. 9 shows an example of modulator 1 obtained by means of the alternative to the method 100. This is a cross-section of the modulator 1. The second layer 22 includes two sublayers A and B. The first sub-layer A extends over the first layer 21 and in particular over the upper surface 210 of the first layer 21. Etching 103 of the side trenches is performed, for example, through this first sub-layer A. The second underlayer B is deposited on the first underlayer A so as to thicken the second layer 22 and close the openings left by the side trenches 42, 43. The second sublayer B is particular in that it has, at the openings in the first sublayer A, oblique flanks, for example oriented at an angle of between 10° and 45° relative to direction Z and forming a cone above each opening.

The modulator 1 according to the invention can advantageously be implemented in an optical phased array. FIG. 10 illustrates an embodiment of an optical phased array 5 comprising:
a plurality of antennae 52, aligned along one direction and distributed along this direction at a constant pitch d; and
a power divider 51 configured to divide optical power of an incident coherent optical beam, the incident optical beam having a wavelength greater than or equal to the constant pitch d.

In the embodiment of FIG. 10, the optical phased array 5 comprises a plurality of modulators 1 as described previously. Each modulator 1 advantageously comprises a single waveguide 11 (as illustrated in FIG. 1a, FIG. 1b, FIG. 1c, FIG. 2a, FIG. 2b or FIG. 5a, FIG. 5b, FIG. 5c, FIG. 5d), forming part of the optical path between the power divider 51 and one antenna 52 of the plurality of antennae 52.

FIG. 11 illustrates a second embodiment of an optical phased array 5. Unlike the embodiment of FIG. 10, it comprises a single modulator 1 as previously described. The modulator 1 advantageously comprises a plurality of waveguides 11 (as illustrated in FIG. 3a, FIG. 1b, FIG. 1c, FIG. 2a, FIG. 2b or FIG. 5a, FIG. 5b, FIG. 5c, FIG. 5d), each waveguide 11 of the modulator 1 forming part of the optical path between the power divider 51 and an antenna 52.

Said array 5 according to one of the two embodiments may belong to a laser remote sensing system.

1. An optical phase modulator comprising:
a semiconductor substrate,
a first layer of dielectric material extending on the substrate and in a plane, in which at least one waveguide and at least one heater extend along a first direction parallel to the plane, said at least one heater being disposed above said at least one waveguide and thermally coupled to a portion of said at least one waveguide, the first layer of dielectric material comprising, for each waveguide:
at least one first trench, extending along a second direction, parallel to the plane and perpendicular to the first direction, disposed above the heater thermally coupled to the waveguide;
a second trench and a third trench each extending along the first direction, on either side of the waveguide and of the heater thermally coupled to the waveguide, said at least one first trench disposed above the heater thermally coupled to the waveguide opening into the second trench and into the third trench;
a second layer of dielectric material extending in parallel to the plane and on the first layer of dielectric material and covering each first, second and third trench.

2. The modulator according to claim 1, wherein for each waveguide, the second trench and the third trench are discontinuous and each comprise segments separated from each other by the dielectric material of the first layer, aligned along the first direction.

3. The modulator according to claim 1, wherein the semiconductor substrate comprises, for each waveguide, a fourth trench extending along the first direction and disposed under said waveguide, each second trench and each third trench on either side of the waveguide opening into the fourth trench.

4. The modulator according to claim 1, wherein for each waveguide, a distance separating two consecutive first trenches along the first direction is less than 5 μm.

5. The modulator according to claim 1, wherein for each waveguide, the first layer of dielectric material comprises a single first trench whose width, measured along the first direction, is greater than 50% of the length of the heater thermally coupled to the waveguide.

6. The modulator according to claim 1, comprising at least ten waveguides.

7. A method for manufacturing an optical phase modulator, comprising:
forming, on a semiconductor substrate, a first layer of dielectric material extending in a plane, in which at least one waveguide and at least one heater extend along a first direction parallel to the plane, said at least one heater being disposed above said at least one waveguide and thermally coupled to a portion of said at least one waveguide;
etching the first layer of dielectric material so as to form, for each waveguide, at least one first trench, extending along a second direction, parallel to the plane and perpendicular to the first direction, disposed above the heater thermally coupled to the waveguide;
etching the first layer of dielectric material so as to form, for each waveguide, second and third trenches each extending along the first direction, on either side of the waveguide and of the heater thermally coupled to the waveguide, each first trench disposed above the heater thermally coupled to the waveguide opening into the second trench and into the third trench;
forming a second layer of dielectric material extending in parallel to the plane and on the first layer of dielectric material and covering each trench.

8. The method according to claim 7, wherein the step of forming the second layer of dielectric material comprises, before the step of etching the second and third trenches, the following sub-steps of:
filling each first trench with a sacrificial material;
depositing the second layer of dielectric material onto the first layer of dielectric material and covering the sacrificial material in each first trench;
wherein the step of etching the second and third trenches is performed through the second layer of dielectric material, wherein the step of forming the second layer of dielectric material also comprises, after the step of etching the second and third trenches, the following sub-steps of:
removing the sacrificial material from each first trench disposed above each heater; and
thickening the second layer of dielectric material so that it covers each second and third trench.

9. The manufacturing method according to claim 8, wherein the step of thickening the second layer of dielectric material is performed by depositing a low density oxide.

10. An optical phased array comprising:
a plurality of antennae, aligned along one direction and distributed along this direction at a constant pitch;
a power divider configured to divide optical power of an incident coherent optical beam, the incident optical beam having a wavelength greater than or equal to the constant pitch;
an optical phase modulator according to claim 1, said modulator comprising a plurality of waveguides, each modulator waveguide forming part of the optical path between the power divider and one of the plurality of antennae; or
a plurality of the optical phase modulators, each modulator comprising a single waveguide, the waveguide of each modulator forming part of the optical path between the power divider and one of the plurality of antennae.

11. A laser remote sensing system comprising an optical phased array according to claim 10.

12. The modulator according to claim 6, comprising at least one hundred waveguides.
